(19) United States
(12) Patent Application Publication
(10) Pub. No.: US 2006/0027425 A1
(43) Pub. Date: Feb. 9, 2006

(54) ATV QUIK LOCK

(76) Inventor: Sidney Owen Coyer, Osakis, MN (US)

Correspondence Address: Sidney O. Coyer, 14266 Co. RD. 57, OSAKIS, MN, 56360, US

(21) Appl. No.: 10/912,696

(22) Filed: Aug. 6, 2004

(51) Int. Cl. B60T 3/00

(52) U.S. Cl. 188/31; 188/32

(57) ABSTRACT

The ATV QUIK LOCK is a automatic locking device for securing an all terrain vehicle to a trailer.

### BACKGROUND OF THE INVENTION

The most common way of securing an all terrain vehicle to a trailer has been the use of rope, straps or chain and lock. My invention is designed to replace these.

### SUMMARY

The ATV QUIK LOCK provides the rider a new and easy way to secure their machine. A rider may simply drive on a trailer equipped with this unit, step off and securing is done. Thus eliminating the need for other manual tie down procedures.

### BRIEF DESCRIPTION OF THE SEVERAL VIEWS OF THE DRAWING

FIG. 1 cover page shows unit mounted on a trailer with an ATV.

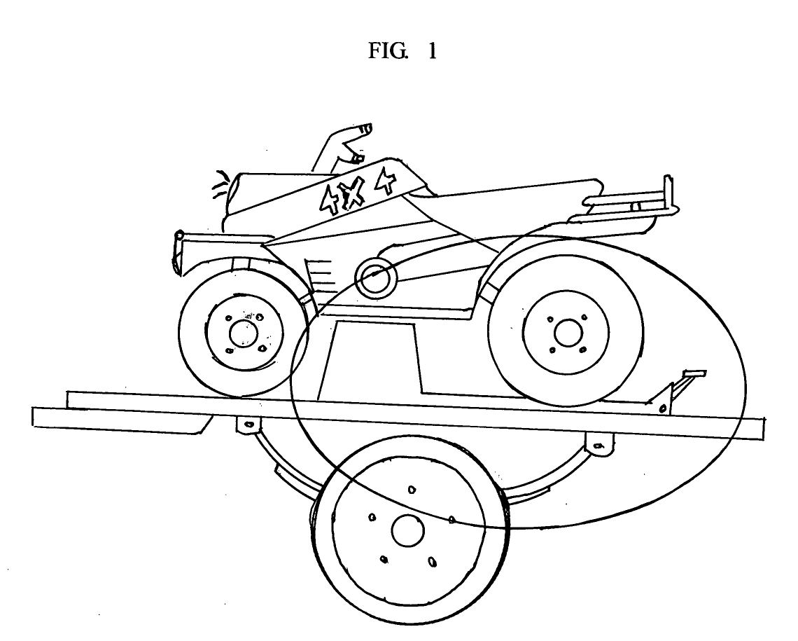

FIG. 2 shows complete unit from the side view.

FIG. 3 shows complete unit from the top view.

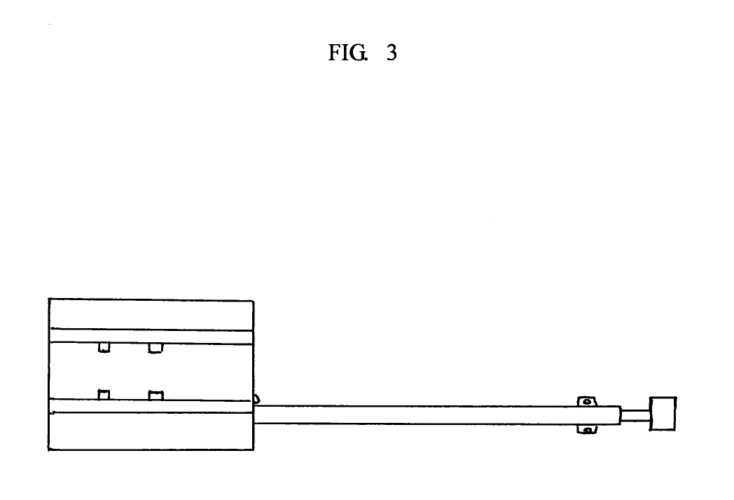

FIG. 4 shows dimensional view of base without cover or pedal assembly.

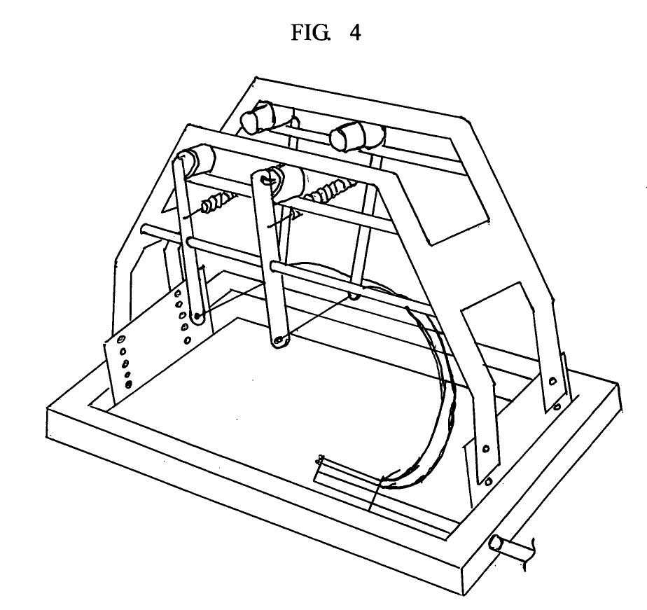

FIG. 5 shows view of pins and pin bars.

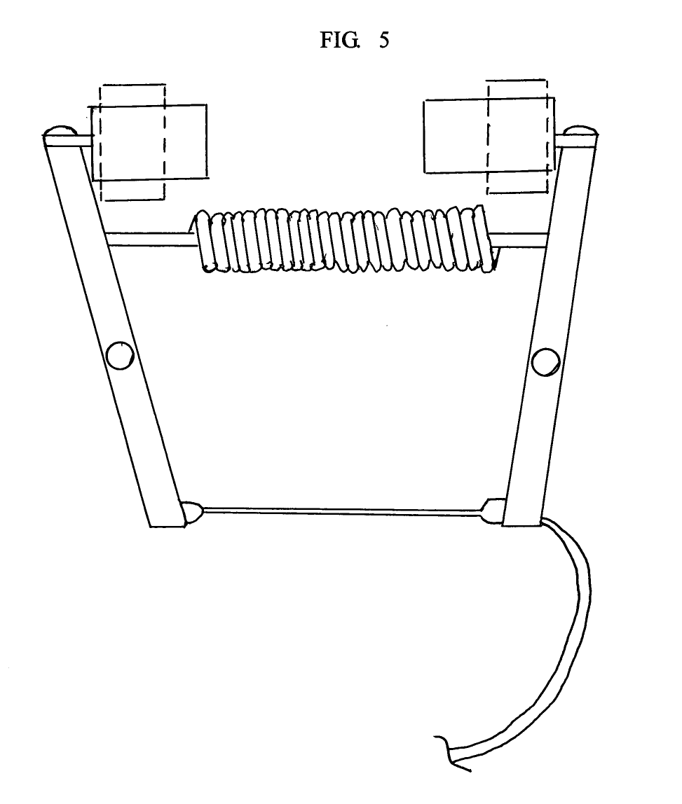

FIG. 6 shows pedal assembly.

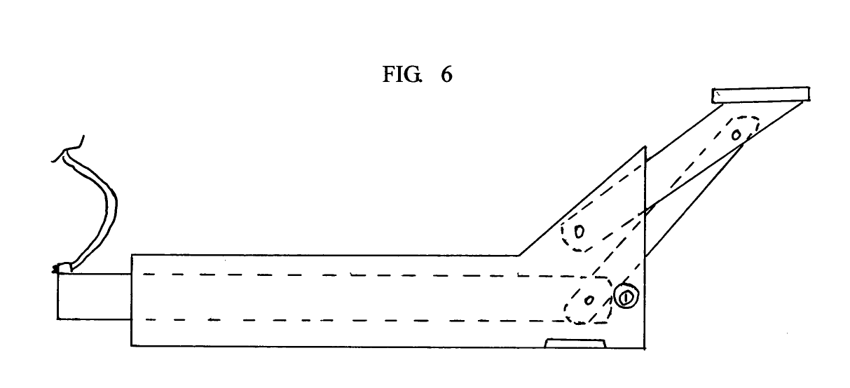

FIG. 7 shows receiver unit from the side view.

FIG. 8 shows receiver unit from the top view.

### DETAILED DESCRIPTION OF THE INVENTION

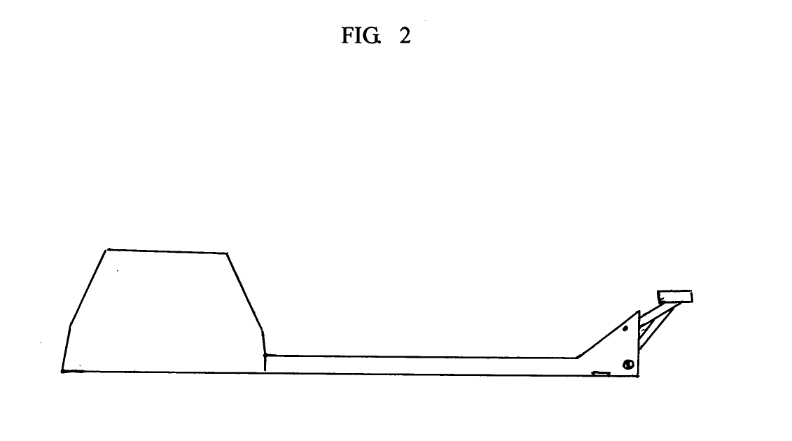

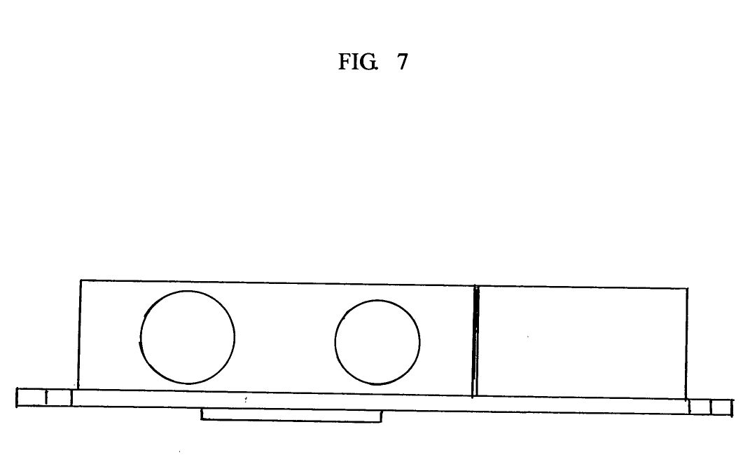

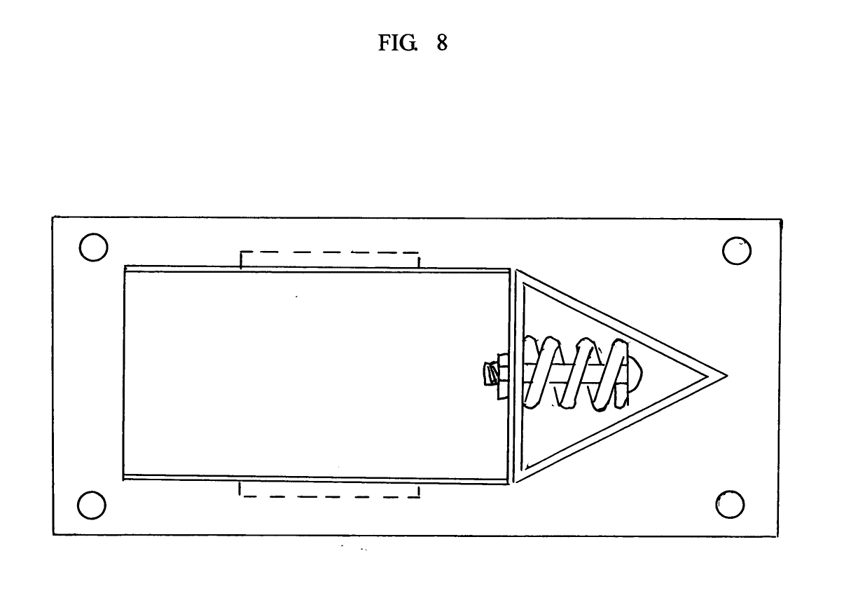

The ATV QUIK LOCK is a drive on/automatic locking securing device. The purpose of this product is to mount an all terrain vehicle to a trailer faster and easier and also provide security. This locking device consists of two main parts. Part one being the base unit FIGS. 2 thru 6 and part two being the receiver FIGS. 7, 8. The base is mounted to a trailer bed. The receiver is mounted to the underside frame of the ATV. The base unit has spring loaded pins that are pushed in by the receiver when the ATV comes in contact. Holes in the receiver accept the pins as the ATV drives forward thus locking the ATV in place. The pedal assembly extends from the base to the rear of the ATV. This is to release the machine, and is key lockable. The rider must stand behind the machine, push down on the pedal and roll the ATV back approximately four inches before getting seated. as the pedal is pushed a connecting rod slides forward into the base, cables are attached to the end of the rod and run to the bottom of the pin bars pulling them together thus backing the pins out of the receiver and releasing it. A spring is attached to the pin bars near the pins that reset the motion and return the pedal to the upright position. A cover shell enclosure protects the internal parts. The base height is adjustable prior to mounting with predrilled holes.

The receiver unit consists of a triangle welded solid to a plate with the block portion being able to slide on a short track and is attached to the triangle with a bolt and spring. When the pins click into the block this provides a shock absorbing action. The pieces of both units are metal.

What I claim my invention is:

1. A automatic locking device for securing an ATV.

2. Provides a positive lock for security.

3. Provides height adjustment to accommodate ATV.S of various ground clearance.

4. Provides shock absorption when securing machine.
